(19) United States
(12) Patent Application Publication
(10) Pub. No.: US 2021/0179815 A1
(43) Pub. Date: Jun. 17, 2021

(54) RECYCLING DISPOSABLE PRODUCTS AND METHODS OF PRODUCING COMPOSITE POLYURETHANE MATERIALS FROM SAME

(71) Applicant: ANDRE LUIS WILMAN REGO, LIBERTYVILLE, IL (US)

(72) Inventor: ANDRE LUIS WILMAN REGO, LIBERTYVILLE, IL (US)

(21) Appl. No.: 16/711,741

(22) Filed: Dec. 12, 2019

(51) Int. Cl. C08K 11/00; C08K 13/08; C08G 18/08

(52) U.S. Cl. CPC C08K 11/005; C08G 18/0838; C08K 13/08

(57) ABSTRACT

This disclosure are methods for recycling disposable products, and using the same to manufacture composite polyurethane materials such as, without limitation, composite polyurethane foams, composite polyurethane elastomers, and composite polyurethane casting resins.

### CROSS-REFERENCE TO RELATED APPLICATIONS

Not applicable.

### BACKGROUND OF THE INVENTION

This invention relates generally to methods of recycling disposable products, and using the same to manufacture composite polyurethane materials such as, without limitation, composite polyurethane foams, composite polyurethane elastomers, and composite polyurethane casting resins.

Recycling disposable products (also known as single use products) has been a challenge around the world and every day disposable products such as, but not limited to, coffee cups, plastic bottles, plastic cups, plastic cup lids, paper cup sleeves, plastic or paper plates, plastic cutlery, paper or plastic packaging, paper or plastic tablecloth, paper coffee filters, paper or plastic wrappers, plastic tupperware, paper towels, plastic straws, coffee stirrers, dryer sheets, ziploc bags, single-serve coffee pods, and the like, end up in landfills. These products generally consume significant amount of resources to produce, they are used for a short amount of time and subsequently disposed in a trash bin. Despite established recycling programs, data shows that the majority of disposable products end up in landfills.

It is estimated that 16 billion disposable coffee cups are consumed annually. Such consumption rate equates to 6.5 million trees, 4 billion gallons of water, and enough energy to power 54,000 houses every year. The thin polyethylene linen inside the disposable coffee cup makes sure liquid doesn't soak through the paper exterior of the cup, and recycling companies need to add additional steps in their recycling process to separate the plastic linen from the paper. Because of the plastic linen, almost 99% of disposable coffee cups end up in landfills.

In 2017, according to the Environment Protection Agency in the United States, plastics generation was 35.4 million tons. Only 8.4 percent of that was recycled.

In 2018, a study published in the journal Science Advances estimated that 8.3 billion metric tons of plastic was manufactured over six decades, most of it were disposable products. About 76% (6.3 billion metric tons) became plastic waste and only 9% of that were actually recycled.

It is important to note that alternatives to disposable products are readily available. However, the benefit-cost ratio of disposable products is high for manufacturers, businesses and consumers. For example, over thirty years, companies like Starbucks have unsuccessfully changed consumer behavior to reduce usage of disposable coffee cups. As of spring 2017, it was reported that only 1.4% of Starbucks' beverages were sold in reusable cups.

In summary, the convenience and operational efficiency of disposable products in modern societies create an ever growing challenge to our environment. They consume a significant amount of resources to produce, and have a very short usage time span. Disposable products are part of our daily lives and there is not yet a catalyst to significantly reduce manufacturing of disposable products, their consumption and subsequent disposal in landfills around the world. This invention describes methods for recycling disposable products, and using the same to manufacture polyurethane composite materials to create long lasting second generation products.

### SUMMARY OF THE INVENTION

This invention provides methods for recycling disposable products such as, but not limited to, coffee cups, plastic bottles, plastic cups, plastic cup lids, paper cup sleeves, plastic or paper plates, plastic cutlery, paper or plastic packaging, paper or plastic tablecloth, paper coffee filters, paper or plastic wrappers, plastic tupperware, paper towels, plastic straws, coffee stirrers, dryer sheets, ziploc bags, single-serve coffee pods, and the like, and using the same to manufacture composite polyurethane materials as part or whole second generation products such as, but not limited to, enclosures, furniture, mechanical parts, floor covering, decking, wall covering, brick pavers, landscape products, hurricane boards, garage doors, garage flooring, storage boxes, trash containers, wheels and tires, foam pads, underlays, backing materials, insulation panels.

The initial steps on all methods herein described is to clean and sanitize post consumer disposable products, remove moisture, and reduce into small fragments, flakes, or the like, using conventional methods such as, without limitation, shredding, grinding, cutting, slicing, chopping or shearing, or a combination thereof. Those of ordinary skill in the relevant art might change the sequence of these steps based on the type of disposable products to be recycled. The disposable products fragments, flakes, or the like, are then homogeneously blended with polyurethane components comprise of an isocyanate component and a polyol component to form the disclosed composite polyurethane material. The uncured composite polyurethane material can be pressure injected (or gravity fed) into a mold, and then cured under proper conditions to set and form, creating a second generation product.

The methods herein described of recycling disposable product materials provide the following benefits: (1) Reduction of post consumer disposable products on landfill sites; (2) Reduction of the amount of virgin polyurethane components required to manufacture products resulting in lower raw material costs; (3) Disposable products fragments/flakes of various sizes can provide structural reinforcement to polyurethane foam, polyurethane elastomer or polyurethane casting resins; (4) Rapid and low cost implementation of this invention due to its simple methods herein described; (5) The low or no impact to consumers and businesses can lead to high adoption of this invention.

This summary description and detailed description are not restrictive of the invention and its methods as disclosed.

### BRIEF DESCRIPTION OF THE DRAWINGS

For a better understanding of the present disclosure, an example of an apparatus is shown in the attached drawing.

FIG. 1 shows an exemplary apparatus for recycling disposable products and using the same to manufacture the disclosed composite polyurethane materials.

### DETAILED DESCRIPTION

The following detailed description, examples, drawings, and claims, and their previous and following descriptions do not limit this invention to the specific or exemplary composite materials, products, and/or methods disclosed. Instead the following detailed description is intended to be illustrative so that others may follow its teachings. Also, it is understood that the terminology used herein are intended to describe specific composite materials, products, and/or methods and it is not intended to be limiting. Accordingly, those of ordinary skill in the relevant art will appreciate that modifications can be made to the present invention while still obtaining the beneficial results of the same. Such modifications and adaptations to the present invention are possible and they are a part of the present invention. Thus, the following description is again provided as illustrative of the principles of the present invention and not in limitation thereof.

Disposable products are generally any single use products such as, but not limited to, coffee cups, plastic bottles, plastic cups, plastic cup lids, paper cup sleeves, plastic or paper plates, plastic cutlery, paper or plastic packaging, paper or plastic tablecloth, paper coffee filters, paper or plastic wrappers, plastic tupperware, paper towels, plastic straws, coffee stirrers, dryer sheets, ziploc bags, single-serve coffee pods, and the like. The materials described herein are provided as examples and not intended to be limiting of the current and future materials used to manufacture disposable products. Disposable product materials refer generally to any material obtained from disposable products.

Disposable products can be obtained from a variety of post-consumer sources such as, but not limited to, municipal waste collection sites, recycling centers, coffee shops, restaurants, residential waste collection, commercial waste collection, standalone disposable products waste collection units, manufacturing facilities, and the like. It is understood that upon collection and sorting, disposable products can contain one or more impurities and other known waste material due to its use, disposal, and/or waste collection process. Alternatively, disposable products can be a pre-consumer product, such as manufacturing remnants or quality control failures.

The following methods are examples of how disposable products can be recycled and use the same to manufacture the disclosed composite polyurethane materials either continuously or in batches. Those of ordinary skill in the relevant art will appreciate that modifications can be made to these methods while still obtaining the beneficial results of the same. Such modifications and adaptations to these methods are possible and they are a part of the present invention.

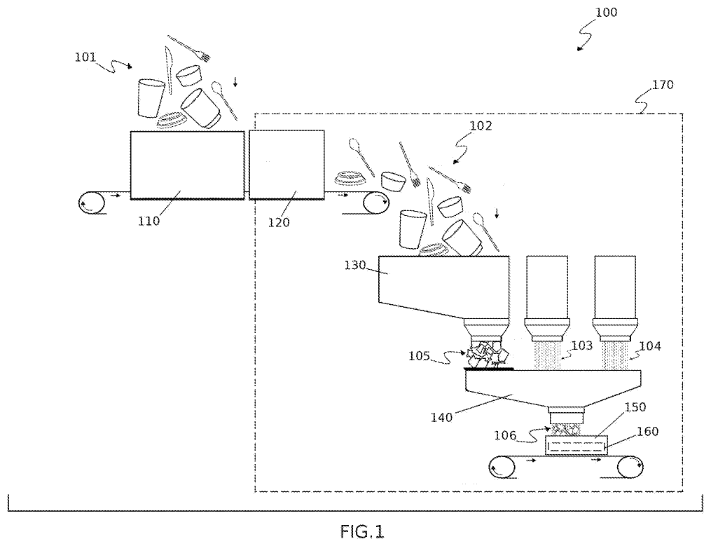

FIG. 1 shows an exemplary apparatus 100 for recycling disposable products materials and using the same to manufacture the disclosed composite polyurethane materials. Disposable products 101 are collected from a pre- or post-consumer sources. Based on ones requirement, non-desirable disposable products such as medical, hygiene and/or electronic products can be removed from further processing. The disposable products selected to continue processing are then moved into apparatus 110 to be cleaned and sanitized using various known methods for same, such as, but not limited to, freezing, heating, sedimentation, UV light, irradiation, ultrasound, ozone, chlorine, fungicide, degreaser.

Once the cleaning and sanitation cycles are completed in apparatus 110, the cleaned and sanitized disposable products are moved into the dehydrator equipment 120. The dehydration process should operate for a period of time necessary to significantly reduce or eliminate moisture on the disposable products materials. The next step is to move the cleaned, sanitized and dehydrated disposable products 102 into a material reduction machinery 130 to reduce all disposable products to fragments, flakes, or the like, and creating aggregate material 105. The material reduction machinery can use various conventional methods such as, without limitation, shredding, grinding, cutting, slicing, chopping or shearing or a combination thereof. Upon completion of the material reduction process, the disposable products fragments, flakes, or the like, are moved to the blender equipment 140 or to a storage location kept at temperature ranges between 15-27° C. (60-80° F.) with relative humidity of 50% or less. Three subsequent exemplary methods are described below to achieve the desirable properties of the disclosed composite polyurethane materials, such as, without limitation, hardness, tensile strength, compression strength, impact resistance, abrasion resistance, and tear strength.

One method comprises homogeneously blending in the blender equipment 140, the disposable products fragments, flakes, or the like, aggregate material 105, with a polyurethane elastomer-forming isocyanate component 103 and a polyol component 104, creating the uncured composite polyurethane elastomer-forming material 106. This method further comprises pressure injecting (or gravity feeding) the uncured material 106 into a mold 150 such that the composite polyurethane elastomer-forming material is cured and a second generation product 160 is created. Furthermore, the material 106 in mold 150 is cured under conditions effective to set and form the composite polyurethane elastomer based upon specific polyurethane formulation used and can be determined by one of ordinary skill in the art without requiring any further experimentation. It is understood that in most instances the conditions effective to cure will not comprise heating the mixture to a temperature that would meet or exceed the melting point of the recycled disposable products materials present in the homogenous blend. The uncured composite polyurethane elastomer-forming material 109 can be formulated to contain disposable products fragments, flakes, or the like, in any desired amount, for example in the range greater than 0% and less or equal to 90% by volume of the resulting composite polyurethane elastomer.

A second method comprises homogeneously blending in the blender equipment 140, the disposable products fragments, flakes, or the like, material 105, with a polyurethane foam-forming isocyanate component 103 and a polyol component 104, creating the uncured composite polyurethane foam-forming material 106. This method further comprises pressure injecting (or gravity feeding) the uncured material 106 into a mold 150 such that the composite polyurethane foam-forming material is cured and a second generation product 160 is created. Furthermore, the material 106 in mold 150 is cured under conditions effective to set and form the composite polyurethane foam-forming based upon specific polyurethane formulation used and can be determined by one of ordinary skill in the art without requiring any further experimentation. It is understood that in most instances the conditions effective to cure will not comprise heating the mixture to a temperature that would meet or exceed the melting point of the recycled disposable products materials present in the homogenous blend. The uncured composite polyurethane foam-forming material 109 can be formulated to contain disposable products fragments, flakes, or the like, in any desired amount, for example in the range greater than 0% and less or equal to 90% by volume of the resulting composite polyurethane foam-forming.

Another method comprises homogeneously blending in the blender equipment 140, the disposable products fragments, flakes, or the like, material 105, with a polyurethane casting resin-forming isocyanate component 103 and a polyol component 104, creating the uncured composite polyurethane casting resin-forming material 106. This method further comprises pressure injecting (or gravity feeding) the uncured material 106 into a mold 150 such that the composite polyurethane casting resin-forming material is cured and a second generation product 160 is created. Furthermore, the material 106 in mold 150 is cured under conditions effective to set and form the composite polyurethane casting resin based upon specific polyurethane formulation used and can be determined by one of ordinary skill in the art without requiring any further experimentation. It is understood that in most instances the conditions effective to cure will not comprise heating the mixture to a temperature that would meet or exceed the melting point of the recycled disposable products materials present in the homogenous blend. The uncured composite polyurethane casting resin-forming material 109 can be formulated to contain disposable products fragments, flakes, or the like, in any desired amount, for example in the range greater than 0% and less or equal to 90% by volume of the resulting composite polyurethane casting resin.

It is understood that all apparatus contained in 170 must be enclosed in an area where temperature ranges between 15-27° C. (60-80° F.), and the relative humidity is kept at 50% or less, and there is no direct exposure to sunlight.

Those of ordinary skill in the pertinent art will recognize that many modifications and adaptations to the present invention are possible and may even be desirable in certain circumstances. Further steps can be added to the methods described herein, for example the composite can be pressed, smoothed, embossed or contoured to obtain various functional or aesthetic effects. Other optional materials can be applied to homogeneous blend or the formed composite during the manufacturing process. Additives such as a colorant, a foaming agent, a viscosity modifier, a compatibilizer, a chain extender, a surfactant, a blowing agent, a cross linker, an antimicrobial agent, a flame retardant, a light stabilizer, and a filler can be added to control and modify the reaction process and performance characteristics of the resulting polyurethane polymer. Fillers can include, for example, calcium carbonate, aluminum oxide trihydrate, calcined clay, wollastonite, coal fly ash, iron oxide, and barium sulfate, or mixtures thereof. Such modifications, adaptations and/or additions to these methods are possible and they are a part of the present invention.

The present invention provides methods for recycling disposable products and use the same to manufacture the disclosed polyurethane composites. These methods provide alternative avenues for recycling disposable products in a manner that significantly reduces the need to send the disposable products materials to landfill sites.

Furthermore, these methods provide ways in which disposable products materials can be integrated into second generation products such as, but not limited to, furniture, mechanical parts, floor covering, decking, wall covering, brick pavers, landscape products, hurricane boards, garage doors, garage flooring, storage boxes, trash containers, wheels and tires, foam pads, underlays, backing materials, insulation panels.

The methods described herein may be used for recycling disposable products or other materials having similar chemical make-up found in disposable products.

The methods herein described for recycling disposable products provide the following benefits: (1) Reduction of post consumer disposable products on landfill sites; (2) Reduction of the amount of virgin polyurethane components required to manufacture products resulting in lower raw material costs; (3) Disposable products fragments/flakes of various sizes can provide structural reinforcement to polyurethane foam, polyurethane elastomer or polyurethane casting resins; (4) Rapid and low cost implementation of this invention due to its simple methods herein described; (5) The low or no impact to consumers and businesses can lead to high adoption of this invention.

What is claimed is:

1. A method of using reclaimed pre- or post-consumer disposable products to manufacture composite polyurethane materials, comprising:
reclaiming one or more disposable products materials;
homogeneously blending one or more disposable products materials with one or more polyurethane forming compositions; and
curing the homogeneous blend of one or more disposable products materials with one or more polyurethane forming compositions to form a composite polyurethane material.

2. The method of claim 1 further comprising reduction of the disposable products materials into small fragments, flakes, or the like, using any conventional method such as, without limitation, shredding, grinding, cutting, slicing, chopping or shearing or a combination thereof.

3. The method of claim 1 further comprising applying freezing, heating, sedimentation, UV light, irradiation, high pressure, ultrasound, ozone, chlorine, fungicide and/or degreaser to disposable products, or disposable products materials fragments, flakes, or the like, to remove oil, grease, resins, ink, gums, and numerous other soils and to kill bacteria, fungi and other microbes.

4. The method of claim 1 further comprising dehydrating the disposable products materials, or the disposable products material fragments, flakes, or the like, to significantly reduce or eliminate material moisture.

5. The method of claim 1 further comprising incorporating the cured homogeneous blend of one or more disposable products materials with one or more polyurethane elastomer-forming compositions in part or as a whole second generation products.

6. An article manufactured according to the method of claim 1.

7. The method of claim 1 wherein the one or more polyurethane forming compositions comprise various types of an isocyanate component with a range of polyols component.

8. The method of claim 7 further comprising adding one or more additives such as, without limitation, a colorant, a foaming agent, a viscosity modifier, a compatibilizer, a chain extender, a surfactant, a blowing agent, a cross linker, an antimicrobial agent, a flame retardant, a light stabilizer, and a filler.

9. The method of claim 7 wherein a filler comprises, without limitation, coal fly ash, iron oxide, calcium carbonate, aluminum oxide trihydrate, calcined clay, wollastonite, and barium sulfate.
